(19) United States
(12) Patent Application Publication
(10) Pub. No.: US 2006/0193122 A1
(43) Pub. Date: Aug. 31, 2006

(54) Light-emitting zipper head

(76) Inventor: Mo-Hsin Chang, Tainan Hsien (TW)

Correspondence Address: BACON & THOMAS, PLLC, 625 SLATERS LANE, FOURTH FLOOR, ALEXANDRIA, VA, 22314, US

(21) Appl. No.: 11/064,945

(22) Filed: Feb. 25, 2005

(51) Int. Cl. F21V 21/08

(52) U.S. Cl. 362/103

(57) ABSTRACT

A light-emitting zipper head includes a light-emitting unit fixed on the rear side of the zipper head or the pull head of the zipper. The light-emitting unit consists of a light emitter, a battery and a changeover switch. When the light emitter is powered, it gives out light, which shines through the transparent zipper head or the pull head to enable the zipper head or the pull head look like exotic and strange.

### BACKGROUND OF THE INVENTION

1. Field of the Invention

This invention relates to a zipper head, particularly to one having a light-emitting function to look very dizzy and exotic when in use.

2. Description of the Prior Art

Conventional zippers are used only for fastening clothes, bags, etc. quite monotonous and not intriguing at all, so they do not satisfy curiosity of adolescents generally fond of variations.

### SUMMARY OF THE INVENTION

The feature of the invention is a light-emitting unit fixed on a rear side of a zipper head or the pull head of a zipper, and the light-emitting unit includes a light emitter, a battery supplying the light emitter with electricity and a changeover switch. When the light emitter powered gives out light, the light shines through the front side of the zipper head, letting the zipper head look like very exotic and strange.

### BRIEF DESCRIPTION OF DRAWINGS

This invention will be better understood by referring to the accompanying drawings, wherein:

FIG. 1 is a front view of a first embodiment of a light-emitting zipper head in the present invention;

FIG. 2 is a perspective view of the first embodiment of the light-emitting zipper head in the present invention;

FIG. 3 is an exploded perspective view of the first embodiment of the light-emitting zipper head in the present invention;

FIG. 4 is a side cross-sectional view of the first embodiment of the light-emitting zipper head in the present invention;

FIG. 5 is a side cross-sectional view of the first embodiment of the light-emitting zipper head under the using condition in the present invention;

FIG. 6 is an exploded perspective view of a second embodiment of a light-emitting zipper head in the present invention; and,

FIG. 7 is a side cross-sectional view of the second embodiment of a light-emitting zipper head under the using condition in the present invention.

### DETAILED DESCRIPTION OF THE PREFERRED EMBODIMENTS

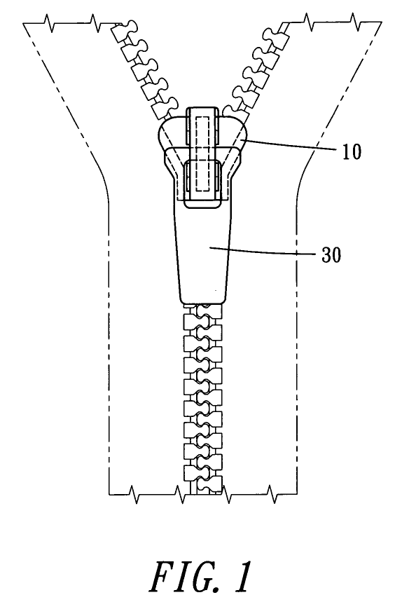

A first embodiment of a light-emitting zipper head in the present invention, as shown in FIGS. 1, 2 and 3, includes a zipper head 10, and a light-emitting unit 20 as main components combined together.

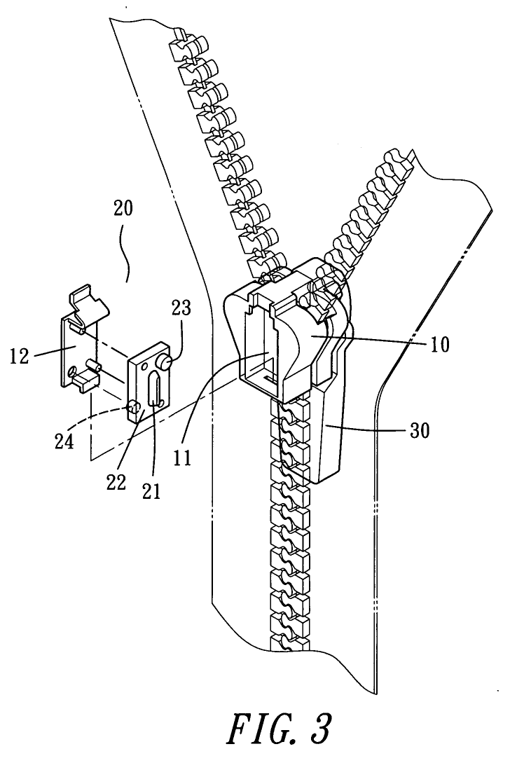

The zipper head 10 is transparent, having a recess 11 formed in its rear side as shown i FIG. 3, and a protective cap 12 is provided to close on the recess 11.

The light-emitting unit 20 is fixed on a rear surface of the protective cap 12 and received in the recess 11, consisting of a light emitter 21, an electronic board 22, a battery 23, and a changeover switch 24. The electronic board 22 is fixed on the rear side of the cap 12, and the light emitter 21 (may be LED), the battery 23 and the changeover switch 24 are deposited properly on the electronic board 22. The changeover switch 24 is connected between the light emitter 21 and the battery 23.

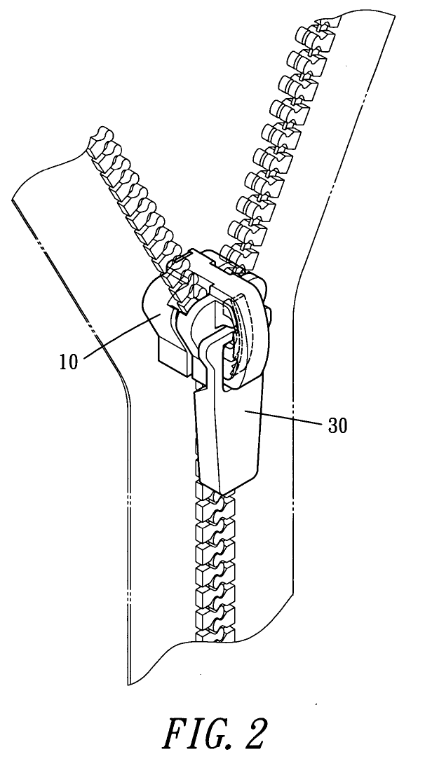

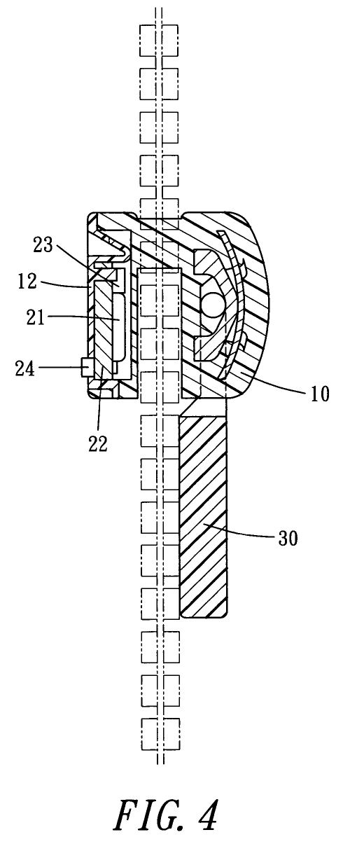

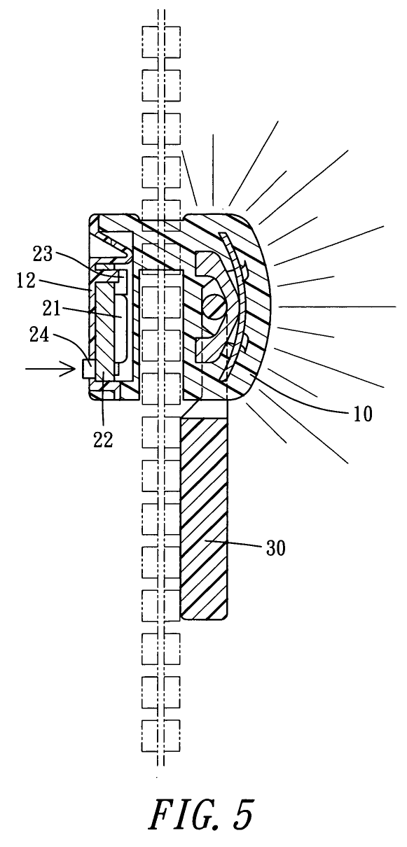

In using the light-emitting zipper head, referring to FIGS. 2 and 4, the changeover switch 24 is flicked to turn on the light emitter 21, which then gives out light to shine through the front side of the transparent zipper head 10. As shown in FIG. 5, the color of the light can be optional to match with an object the zipper is to be used for, and the lighting can be set constant or on-and-off.

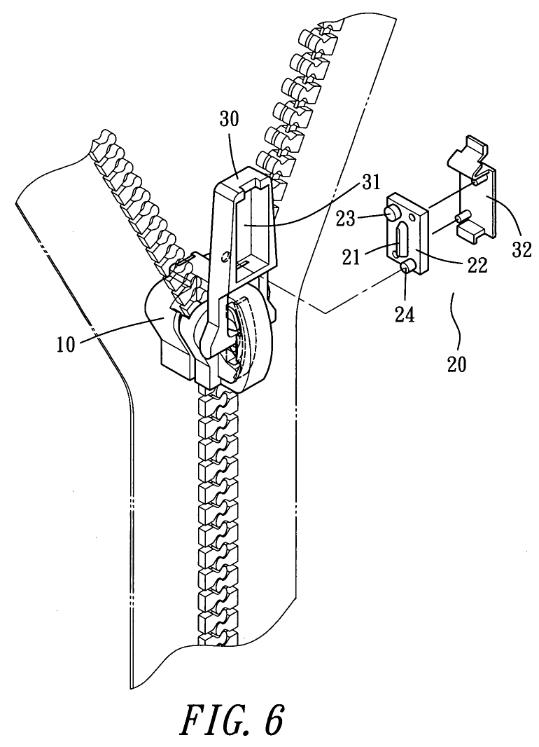

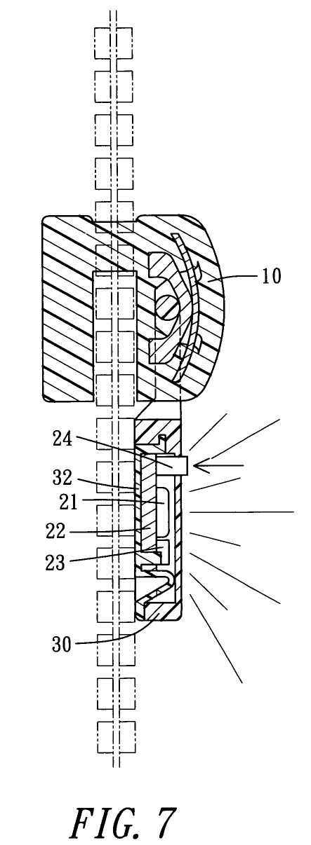

Next, FIGS. 6 and 7 show a second embodiment of a light-emitting zipper head in the invention, and it includes a pull head 30, and a light-emitting unit 20 as the same as that used in the first embodiment. The light-emitting unit 20 is fixed on a rear side of a protective cap 32, which is then closed on the recess 3.1 in the rear side of the pull head 30, with the light-emitting unit 20 received in the recess 31 of the pull head 30.

In using the second embodiment of a light-emitting zipper head, the switch 24 is flicked to turn on the light emitter 21, which then gives out light to shine through the front side of the transparent pull head 30. So the transparent pull head 30 may look like exotic and strange to greatly intrigue adolescents.

Further, if the light-emitting zipper head is to be applied on clothes needing washing, the protective cap 12, 32 can be designed to be removable so the light-emitting unit 20 may be removed temporarily for preventing the light-emitting unit 20 from getting wet. Of course, provided that the protective cap 12, 32 and the recess 11, 31 are treated especially to be water-proof, then the protective cap 12 or 32 does not need to be removed off.

The light-emitting zipper head according to the invention has the following advantages, as can be seen from the foresaid description.
1. It may look exotic and strange.
2. It has a warning safety during the nighttime.

While the preferred embodiments have been described above, it will be recognized and understood that various modifications may be made therein and the appended claims are intended to cover all such modifications that may fall within the spirit and scope of the invention.

What is claimed is:

1. A light-emitting zipper head comprising a light-emitting unit fixed on a rear side of a transparent zipper head, said light-emitting unit consisting of a light emitter, a batter, and a changeover switch; the light given out by said light emitter shining through the transparent zipper head to enable said zipper head look like exotic and strange when said light emitter is powered.

2. A light-emitting zipper head comprising a light-emitting unit fixed on the rear side of a pull head of a zipper, said light-emitting unit consisting of a light emitter, a battery and a changeover switch; the light given out by said light emitter shining through a front side of said pulling head to enable said pull head look like exotic and strange.

3. The light-emitting zipper head as claimed in claim 1, wherein said zipper head is provided with a recess for receiving said light-emitting unit, and a protective cap closes on said recess, with said light-emitting unit fixed on the rear side of said protective cap.

4. The light-emitting zipper head as claimed in claim 2, wherein said zipper head is provided with a recess for receiving said light-emitting unit, and a protective cap closes on said recess, with said light-emitting unit fixed on the rear side of said protective cap.
